(19) United States
(12) Patent Application Publication
(10) Pub. No.: US 2003/0025828 A1
(43) Pub. Date: Feb. 6, 2003

(54) Headset video recorder

(76) Inventors: Gregory Ramonowski, Schenectady, NY (US); Roland Ramonowski, Schenectady, NY (US)

Correspondence Address: HOFFMAN WARNICK & D'ALESSANDRO, LLC, 3 E-COMM SQUARE, ALBANY, NY, 12207

(21) Appl. No.: 09/920,022

(22) Filed: Aug. 1, 2001

(51) Int. Cl. H04N 5/225

(52) U.S. Cl. 348/376

(57) ABSTRACT

A video recorder for coupling to a head of a user. The headset video recorder includes a head assembly for securing to the head of a user; a data recorder coupled to the head assembly; and a camera, communicative with the data recorder, coupled to the head assembly.

### BACKGROUND OF THE INVENTION

1. Technical Field

The present invention relates generally to a portable video recorder, and more particularly, to a headset with a data recorder and camera coupled thereto.

2. Related Art

Portable video recorders are favored mechanisms for recording family gatherings, children at play, sporting events and other activities to be reviewed at a later date. The typical video recorder transfers information to a tape. The players are typically compact and portable/hand held.

The body of a portable video recorder is usually made from a mold that is tooled and/or shaped to correspond to the size that is needed to encompass the elements for the electronic parts and the data disk or tape. The materials used to make the body of the compact disk are usually a form of polyurethane, polyethylene or the like. The body is made to be light, strong, and resistant to elements like moisture, sweat and dirt.

Unfortunately, currently available video recorders suffer from a number of disadvantages. For instance, when using existing recorders, it is necessary to carry the recorder while recording an event. This makes it hard to enjoy an event while recording because of the fatigue involved while holding the arm in an upright position.

Another disadvantage of currently available portable video recorders is that the user's peripheral vision is impaired. While the current video recorders are being used, the user's peripheral vision is impaired by holding the recorder up to the side of the head. This can be a safety concern for the user of the current portable video recorders. The user will be paying strict attention to the activity being recorded, and one of the senses will be impaired through use of a current video recorder.

Also, the current video camera systems record an image onto various tapes. The recording tapes are fragile and may be destroyed easily.

Currently there are micro cameras installed in a catchers mask for baseball, or even a race car for views from inside of the auto. The current camera systems transmit a video signal for a real time image that is sent over satellite to be distributed to an audience, and do not record data.

In view of the foregoing, there is a need for a headset with an attached camera and data recorder.

### SUMMARY OF THE INVENTION

In a first aspect of the invention is provided a headset video recorder comprising: a data recorder operatively coupled to a camera by a strap, wherein the strap is adapted to be coupled to a head of a user.

In a second aspect of the invention is provided a headset video recorder comprising: a head assembly for securing to the head of a user; a data recorder coupled to the head assembly; and a camera, communicative with the data recorder, coupled to the head assembly.

In a third aspect of the invention is provided a headset video recorder comprising: a first assembly for securing to the head of the user; a first housing coupled to the first assembly; a second housing coupled to the first assembly; a second assembly coupled to at least one housing; a data recorder coupled to one of the first assembly, second assembly and the at least one housing; and a camera coupled to one of the first assembly, second assembly and the at least one housing, wherein the camera communicates with the data recorder.

In a fourth aspect of the invention is provided a headset video recorder comprising: means for attaching to a head of a user; mean for recording data; means for attaching the means for recording data to the means for attaching; and means for receiving video data for recording by the means for recording.

In a fifth aspect of the invention is provided a headset video recorder comprising: a head assembly in the form of a strap for mounting to a head of a user; a first housing coupled to the head assembly; a second housing coupled to the head assembly; a camera coupled to one of the first and second housing; and a digital data recorder communicative with the camera for digitally recording video.

The foregoing and other features and advantages of the invention will be apparent from the following more particular description of the preferred embodiments of the invention.

### BRIEF DESCRIPTION OF THE DRAWINGS

Various embodiments of this invention will be described in detail, with reference to the following figures, wherein like designations denote like elements, and wherein:

FIG. 1 is a front view of a headset data disk video recorder according to a first embodiment of the invention;

FIG. 2 is a partial side view of the first embodiment showing a first housing with a camera coupled thereto;

FIG. 3 is another partial side view of the first embodiment showing a second housing with a data disk recorder coupled thereto;

FIG. 4 is a partial side view of the first embodiment showing a swivel coupling device; and

FIG. 5 is a rear view of a second embodiment of the invention.

### DETAILED DESCRIPTION OF THE INVENTION

Referring now specifically to the drawings, there is a headset 10 including a head assembly 42, a camera 12 and a data recorder 60. Headset 10 may also include an infrared detector 50 for receiving signals for controlling operation of the camera and data recorder, a first housing 18, including camera 12 coupled thereto, and a second housing 52, including data recorder 60 coupled thereto.

As illustrated, headset 10 is portable and adapted to be secured to the head/neck area of a user. However, as will be recognized by those skilled in the art, the teachings of the invention are not limited to just portable data disk video recorders. Finally, it should be known that some or all of the housings described below are not required to implement the invention.

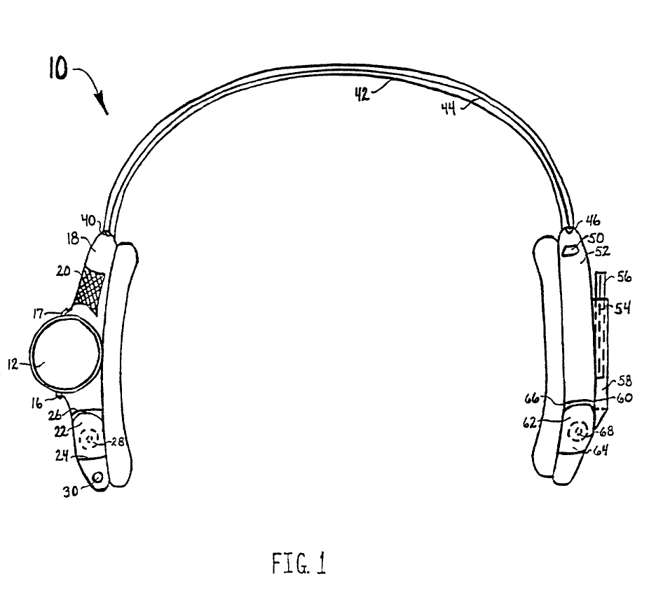

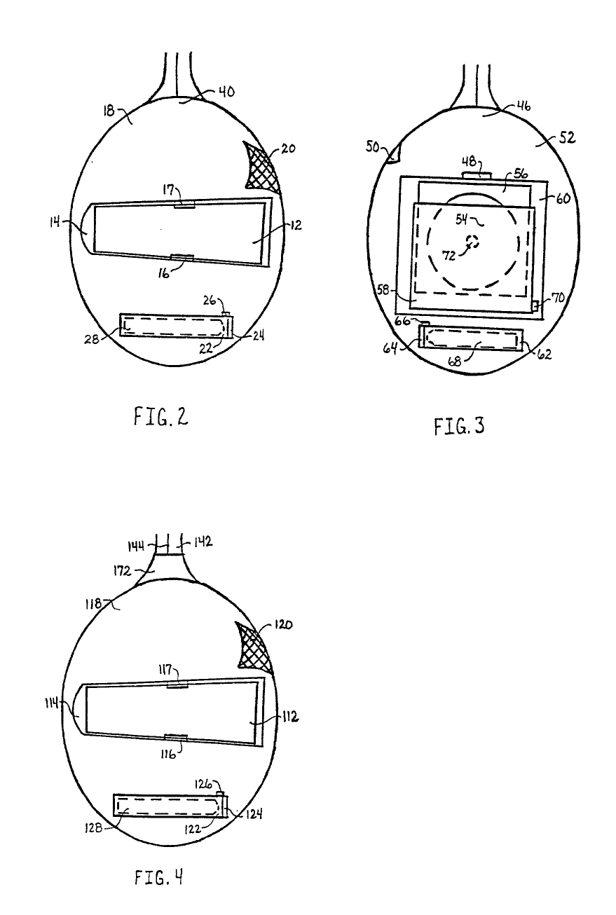

In a first embodiment, shown in FIGS. 1-3, camera 12 is coupled to first housing 18 using camera couplers 16, 17. It should be recognized that camera 12 may be permanently or detachably coupled to the head assembly 42, or housings 18 or 52. Numerous mechanisms for coupling camera 12 are possible, including a slot, hinge, compartment, universal joint such as one of a ball and socket type, hook and latch fasteners, clips, glue, buttons, snaps, screws, etc.

A power source housing 22 is shown located in first housing 18. A hinged door 24 may be provided to gain access to power source housing 22. As shown, hinged door 24 is attached to first housing 18 by a hinged fastener 26. It should be recognized, however, that other door mechanisms as known in the art are also possible with the invention, e.g., a retractable door system, detachable door, etc. Additionally, it should be recognized that power source housing 22 may be located in camera 12. A power source 28 may be a dry cell type of power source but other power sources known in the art are also possible with the invention, e.g., corded adaptor plugins, solar cells, etc. Power source 28 is contained in power source housing 22.

An audio receiving element 20 may be coupled to first housing 18. Audio receiving element 20 may be a microphone, speaker, piezoelectric device, or any other device capable of receiving an audio frequency.

A real time image coupling device 30 may be included first housing 18. Real time image coupling device 30 may be used to couple a real time image display, e.g., a display screen, to first housing 18. The real time image display would allow the user to see what is being recorded or to view playback. Of course other methods of displaying a real time image are possible. A real time image display may receive video data by other means known in the art e.g., infrared red transmitters, laser, fiber optic etc.

Referring to FIG. 1, a first end 40 of head assembly 42 is coupled to first housing 18, and a second end 46 of head assembly 42 is coupled to second housing 52. Head assembly 42 may include a padded metal strap. Conductive material 44 is shown included within head assembly 42. Conductive material

44 is used to transmit data between the data recorder 60, camera 12, audio receiving element 20, and infrared detector 50. Conductive material 44 may be comprised of copper wire, aluminum or any other type of conducting material. Camera 12 and data recorder 60 can be either directly connected to conductive material 44, or conductive material 44 may be connected to similar conductive material within housings 18 and 52, which then connects to camera 12, data recorder 60, audio receiver element 20, and infrared detector 50. While conductive material 44 is shown, it should be recognized, that other materials and transmitting devices as known in the art are possible with the invention, e.g., infrared red sensors, fiber optics, lasers, etc.

As shown in FIG. 3, data recorder 60 is shown coupled to second housing 52 using a recorder coupler 48. It should be recognized that data recorder 60 may be permanently or detachably coupled to head assembly 42, or housings 18 or 52. Numerous mechanisms for coupling data recorder 60 are possible including a slot, hinge, compartment, hook and latch fastener, clips, glue, buttons, buckles, snaps, screws, etc. A data storage device compartment 58, formed in a side of data recorder 60, is provided. In one preferred embodiment, data recorder 60 is a digital data disk recorder. A data disk 54 (shown partially inserted) may be placed in a data disk holder 56. A positioning post 72 can be used to keep data disk 54 centralized. A locking tab 70 holds data disk holder 56 in place. When it is necessary to remove data disk 54 and data disk holder 56 from data disk compartment 58, locking tab 70 may be pressed and data disk holder 56 is released. It should be recognized, however, that other locking mechanisms as known in the art are possible with the invention, e.g., a hinged or retractable door system may be used to secure and protect data disk 54 with or without data disk holder 56. Furthermore, other types of data storage now known or later developed may be employed for recording of data, e.g., a digital data stick, digital tape, etc. A power source compartment 62 may be provided in second housing 52. A hinged door 64 may be provided to gain access to power source compartment 62. As shown, hinged door 64 is attached to second housing 52 by a hinged fastener 66. It should be recognized, however, that other door mechanisms as known in the art are also possible with the invention, e.g., a retractable door system, detachable door, etc. Additionally, it should be recognized that power source compartment 62 may be located on data recorder 60. A power source 68 may be a dry cell type of power source but other power sources known in the art are also possible with the invention, e.g., corded adaptor plugins, solar cells, etc. Power source 68 is contained in power source compartment 62.

Infrared detector 50 may be used for remote control of camera 12 and data recorder 60. Of course, other means for controlling camera 12 and data recorder 60 are known in the art. Other means may include e.g., control buttons, laser, fiber optic etc.

Referring to FIG. 4, an alternative embodiment including a swivel type coupling device 172 attached to housing 118 is shown. Housing 118 is coupled to first assembly 142. Coupling device 172 couples housing 118 to first assembly 142 and allows swiveling of housing 118 relative to first assembly 142. Conductive material 144 is shown within first assembly 142. Audio receiver device 120 is attached to housing 118. Camera 112 (electronics not shown) is coupled to camera compartment 114 using camera couplers 117 and 116. A power source compartment 122 is used to hold a power source 128. A lid 124 may be used to gain access to power source compartment 122. A hinge 126 may be used to attach power source lid 124 to first housing 118.

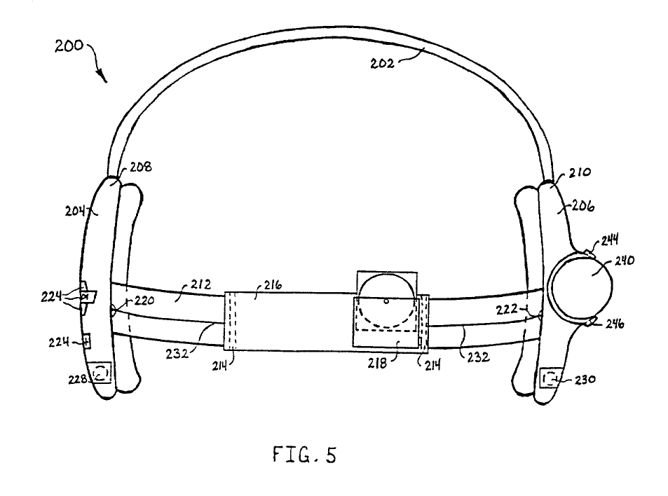

Referring to FIG. 5, a second embodiment of a headset 200 is disclosed. This embodiment includes: a first assembly 202, a first housing 204 coupled to a first end 205 of first assembly 202, a second housing 206 coupled to a second end 210 of first assembly 202, and a second assembly 212 with a first end 220 coupled to first housing 204 and a second end 222 coupled to a second housing 206. Control buttons 224 are located on first housing 204. Control buttons 224 are used to operate data recorder 218 and camera 240. A panel 216 is shown coupled to second assembly 212 using a coupler 214. Panel 216 includes a data disk recorder. Panel 216 may also include control buttons 224 or have a separate panel for control buttons 224 on second assembly 212. Panel 216 may be coupled to housings 204, 206, first assembly 202 or second assembly 212. Mechanisms for coupling panel 216 include a slot, hinge, compartment, hook and latch fastener, clips, glue, buttons, buckles, snaps, screws, etc.

Second assembly 212 contains conductive material 232 that allows data recorder 218 to communicate with camera 240 and control buttons 224. Additionally, conductive material 232 may provide power from a power source 228 and an optional power source 230 to controls 224, data disk recorder 218, and camera 240. It should be recognized that power source 228 and power source 230 may be placed in the same housing. Alternatively, a single power source may be used and placed on panel 216. Control buttons 224, shown on first housing 204, communicate with data disk recorder 218, and camera 240 through conductive material 232. It should be recognized that control buttons 224 may be placed on housings 204, 206, panel 216 or on a second panel coupled to assembly 202 or 212.

In the above embodiments, housings 18, 52, 118, 204, and 206 are made from the same material, e.g., a form of polyurethane, polyethylene, etc. Of course, other synthetic and natural materials having similar structural characteristics may also be utilized if desired.

With regard to the data disk holder described above, it should be recognized that a door may be used to protect the data disk, e.g., hinged door assembly, retractable door system, etc. Additionally, it should be recognized that the data disk is smaller than a standard compact disc (CD), and data disks of sizes other than that shown are possible. Furthermore, while a data disk has been illustrated, any portable, removable data storage means now known or later developed can be used in conjunction with the present invention.

While this invention has been described in conjunction with the specific embodiments outlined above, it is evident that many alternatives, modifications and variations will be apparent to those skilled in the art. Accordingly, the preferred embodiments of the invention as set forth above are intended to be illustrative, not limiting. Various changes may be made without departing from the spirit and scope of the invention as defined in the following claims.

What is claimed is:

1. A headset video recorder comprising:
a data recorder operatively coupled to a camera by a strap, wherein the strap is adapted to be coupled to a head of a user.

2. A headset video recorder comprising:
a head assembly for securing to the head of a user;
a data recorder coupled to the head assembly; and
a camera, communicative with the data recorder, coupled to the head assembly.

3. The headset video recorder of claim 1, further comprising a power source for the camera and the data recorder.

4. The headset video recorder of claim 1, wherein the data recorder is coupled to a housing of the head assembly.

5. The headset video recorder of claim 1, wherein the camera is coupled to a housing of the head assembly.

6. The headset video recorder of claim 1, further comprising an infrared sensor for receiving signals for controlling at least one of the camera and the data recorder.

7. The headset video recorder of claim 1, further comprising an audio receiving element.

8. The headset video recorder of claim 1, wherein the data recorder is digital.

9. A headset video recorder comprising:
a first assembly for securing to the head of the user;
a first housing coupled to the first assembly;
a second housing coupled to the first assembly;
a second assembly coupled to at least one housing;
a data recorder coupled to one of the first assembly, second assembly and the at least one housing; and
a camera coupled to one of the first assembly, second assembly and the at least one housing, wherein the camera communicates with the data recorder.

10. The headset video recorder of claim 8, further comprising an infrared sensor for receiving signals for controlling at least one of the camera and the data recorder.

11. The headset video recorder of claim 8, further comprising an audio receiving element.

12. The headset video recorder of claim 8, further comprising at least one power source to provide power to the camera and the data recorder.

13. The headset video recorder of claim 8, wherein the data recorder is digital.

14. A headset video recorder comprising:
means for attaching to a head of a user;
mean for recording data;
means for attaching the means for recording data to the means for attaching; and
means for receiving video data for recording by the means for recording.

15. A headset video recorder comprising:
a head assembly in the form of a strap for mounting to a head of a user;
a first housing coupled to the head assembly;
a second housing coupled to the head assembly;
a camera coupled to one of the first and second housing; and
a digital data recorder communicative with the camera for digitally recording video.

16. The headset video recorder of claim 14, wherein the digital data recorder is coupled to one of the first and second housing.

17. The headset video recorder of claim 14, further comprising an infrared sensor for receiving signals for controlling at least one of the camera and the data recorder.

18. The headset video recorder of claim 14, further comprising an audio receiving element.

19. The headset video recorder of claim 14, further comprising at least one power source to provide power to the camera and the data recorder.
